(19) United States
(12) Patent Application Publication
(10) Pub. No.: US 2025/0121809 A1
(43) Pub. Date: Apr. 17, 2025

(54) BRAKE SYSTEM

(71) Applicant: HL MANDO CORPORATION, Gyeonggi-do (KR)

(72) Inventors: Kawnseek KIM, Gyeonggi-do (KR); Heechul JUNG, Gyeonggi-do (KR)

(21) Appl. No.: 18/913,281

(22) Filed: Oct. 11, 2024

(30) Foreign Application Priority Data
Oct. 11, 2023 (KR) 10-2023-0135261
Feb. 14, 2024 (KR) 10-2024-0021050

(51) Int. Cl. B60T 13/20; B60T 13/58; B60T 13/68; B60T 17/22; H02P 3/04

(52) U.S. Cl. CPC B60T 13/20; B60T 13/588; B60T 13/686; B60T 17/22; H02P 3/04; B60T 2220/04; B60T 2240/00; B60T 2270/414

(57) ABSTRACT

Disclosed is a brake system. The brake system may include a first power source which supplies power of a first voltage, a motor which receives the power from the first power source and is driven to generate a hydraulic braking pressure while a vehicle travels, a second power source which supplies power of a second voltage that is lower than the first voltage, and a controller which receives the power from the second power source and controls the motor.

### CROSS-REFERENCE TO RELATED APPLICATIONS

This application claims the benefit of and priority to Korean Patent Application No. 10-2023-0135261, filed on Oct. 11, 2023, and Korean Patent Application No. 10-2024-0021050, filed on Feb. 14, 2024, which are incorporated by reference herein in their entireties.

### BACKGROUND

### 1. Technical Field

The present disclosure relates to a brake system, and more specifically, to a brake system which is installed in a vehicle and generates a braking force required for deceleration or stopping of the vehicle when the vehicle travels.

### 2. Discussion of Related Art

Recently, electric brakes in which pedaling amounts of brake pedals of drivers are transmitted as electrical signals to drive motors and braking pressures are generated according to driving of the motors have been widely used. An electric brake can be configured to perform braking through autonomous control and driving of the motor without intervention of the driver, and therefore is very useful for implementing autonomous driving technologies.

Generally, 12V batteries are used as power sources of electrical and electronic apparatuses of vehicles. In such situations, circuits for driving and controlling the electric brakes are also designed to correspond to 12 V.

Meanwhile, electric vehicles driven by motors replacing internal combustion engines have recently been widely provided, and a brake system of such an electric vehicle includes an electric brake. A battery providing a higher voltage (for example, 48 V) than the conventional case is mounted as a driving power source in the electric vehicle. Accordingly, adopting of a high-voltage battery as a power source of an electric brake mounted in an electric vehicle is considered for improving efficiency.

### SUMMARY

The present disclosure is directed to providing a brake system in which a high-voltage power source and a low-voltage power source are combined so that efficiency of power usage and economy of a circuit configuration are maximized.

The present disclosure is directed to providing a brake system in which a power source dualized into a high-voltage power source and a low-voltage power source is used and redundancy is provided by the low-voltage power source in a case in which the high-voltage power source does not provide power.

The objects of the present disclosure are not limited to the above-described objects, and other objects that are not mentioned will be able to be clearly understood by those skilled in the art to which the present disclosure pertains from the following description.

In accordance with one aspect of the present disclosure, there is provided a brake system of a vehicle, the brake system including a first power source which supplies power of a first voltage, a motor which receives the power from the first power source and is driven to generate a hydraulic braking pressure while a vehicle travels, a second power source which supplies power of a second voltage that is lower than the first voltage, and a controller which receives the power from the second power source and controls the motor.

The brake system according to one aspect of the present disclosure may further include an inverter which is disposed between the first power source and the motor and converts the power supplied from the first power source to the motor, wherein the controller may transmit an inverter control signal for controlling the inverter.

The brake system according to one aspect of the present disclosure may further include a motor driver which is disposed between the controller and the inverter and converts the inverter control signal transmitted by the controller to a signal for operating the inverter.

The brake system according to one aspect of the present disclosure may further include a valve which adjusts transmission of the hydraulic braking pressure, wherein the controller may receive the power from the second power source and control the valve.

The brake system according to one aspect of the present disclosure may further include a switch which is disposed between the first power source and the motor and controls on/off of the power supplied from the first power source to the motor.

In the brake system according to one aspect of the present disclosure, the controller may receive monitoring information on one or more of a voltage and a current, which are supplied from the first power source, from the switch.

The brake system according to one aspect of the present disclosure may further include a regulator which is disposed between the second power source and the controller and adjusts a voltage of the power supplied from the second power source to the controller.

The brake system according to one aspect of the present disclosure may further include a motor position sensor which senses a position of the motor, wherein the controller may supply power to the motor position sensor and receive motor position information from the motor position sensor.

The brake system according to one aspect of the present disclosure may further include a pedal displacement sensor which senses displacement of a brake pedal of the vehicle, wherein the controller may supply power to the pedal displacement sensor and receive pedal displacement information from the pedal displacement sensor.

The brake system according to one aspect of the present disclosure may further include a pressure sensor which senses a braking pressure supplied to a wheel of the vehicle, wherein the controller may supply power to the pressure sensor and receive braking pressure information from the pressure sensor.

The brake system according to one aspect of the present disclosure may further include a wheel speed sensor which senses a speed of a wheel of the vehicle, wherein the controller may supply power to the wheel speed sensor and receive wheel speed information from the wheel speed sensor.

The brake system according to one aspect of the present disclosure may further include an electronic parking brake driver which controls an electronic parking brake to provide a parking braking force for maintaining a parked state when the vehicle is parked, wherein the controller may supply power to the electronic parking brake driver and transmit a control signal for controlling the electronic parking brake.

In accordance with another aspect of the present disclosure, there is provided a brake system of a vehicle, the brake system including a first power source which supplies power of a first voltage, a motor which receives the power from the first power source for generating a hydraulic braking pressure while the vehicle travels, a second power source which supplies power of a second voltage that is lower than the first voltage, a controller which receives the power from the second power source and controls the motor, and a converter which is disposed between the second power source and the motor and boosts a voltage supplied by the second power source to the first voltage, and when the first power source does not supply the power to the motor, the controller boosts the power supplied from the second power source to a first voltage using the converter and supplies the boosted first voltage to the motor.

The brake system in accordance with another embodiment of the present disclosure may further include an inverter which is disposed between the first power source and the motor and converts the power supplied from the first power source to the motor, wherein the controller may transmit an inverter control signal for controlling the inverter.

The brake system in accordance with another embodiment of the present disclosure may further include a motor driver which is disposed between the controller and the inverter and converts the inverter control signal transmitted by the controller to a signal for operating the inverter.

The brake system in accordance with another embodiment of the present disclosure may further include a valve disposed to adjust transmission of the hydraulic braking pressure, wherein the controller may receive the power from the second power source and control the valve.

The brake system in accordance with another embodiment of the present disclosure may further include a switch which is disposed between the first power source and the motor and controls on/off of the power supplied from the first power source to the motor.

In the brake system in accordance with another aspect of the present disclosure, the controller may receive monitoring information on one or more of a voltage and a current, which are supplied from the first power source, from the switch.

The brake system in accordance with another embodiment of the present disclosure may further include a regulator which is disposed between the second power source and the controller and adjusts the voltage of the power supplied from the second power source to the controller.

The brake system in accordance with another embodiment of the present disclosure may further include a motor position sensor which senses a position of the motor, wherein the controller may supply power to the motor position sensor and receive motor position information from the motor position sensor.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view illustrating a configuration of a brake system according to one embodiment of the present disclosure;

FIG. 2 is a detailed view illustrating the configuration of the brake system according to one embodiment of the present disclosure;

FIG. 3 is a schematic view illustrating a configuration of a brake system according to another embodiment of the present disclosure; and

FIG. 4 is a detailed view illustrating the configuration of the brake system according to another embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

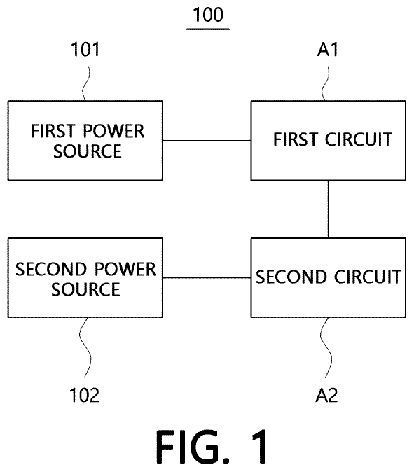

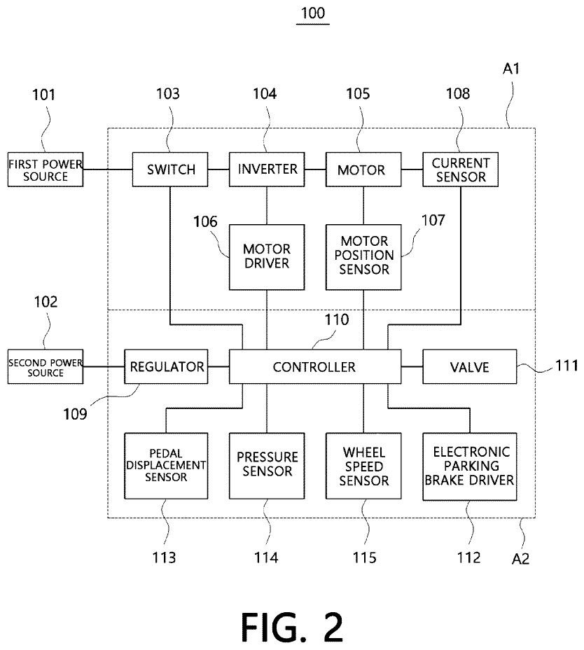

FIG. 1 is a schematic view illustrating a configuration of a brake system according to one embodiment of the present disclosure, and FIG. 2 is a detailed view illustrating the configuration of the brake system according to one embodiment of the present disclosure.

A brake system 100 according to one embodiment of the present disclosure is applied to a vehicle. More specifically, the brake system 100 is disposed in the vehicle and generates a braking force required for deceleration or stopping of the vehicle when the vehicle travels.

The brake system 100 may be an electric brake system in which a pedaling amount of a brake pedal of a driver is transmitted as an electrical signal to drive a motor and a braking pressure is generated according to the driving of the motor. In addition, the brake system 100 which is mounted in a vehicle capable of autonomous driving, drives a motor according to a traveling situation without a driver operating a brake pedal, and generates a braking pressure according to the driving of the motor may also be considered.

Referring to FIGS. 1 and 2, the brake system 100 according to one embodiment of the present disclosure includes a first power source 101 and a second power source 102. That is, the brake system 100 has a dualized power structure.

The first power source 101 supplies power of a first voltage. More specifically, the first power source 101 may supply direct current (DC) power having the first voltage. The first power source 101 may be a battery for supplying the first voltage. For example, the first voltage may be 48 V.

The second power source 102 supplies power of a second voltage that is lower than the first voltage. More specifically, the second power source 102 may supply DC power having the second voltage. The second power source 102 may be a battery providing the second voltage. For example, the second voltage may be 12 V.

The power of the first voltage supplied by the first power source 101 is used for driving a motor 105. Meanwhile, the power of the second voltage supplied by the second power source 102 may be used for controlling the motor 105. Still more specifically, the second power source 102 may be used for operating a controller 110 which controls the motor 105.

The brake system 100 may include a first circuit A1 including the motor 105 driven by the first power source 101 and components for driving or monitoring the motor 105 and a second circuit A2 including the controller 110 operated by the second power source 102.

In one embodiment of the present disclosure, a switch 103, an inverter 104, a motor driver 106, a motor position sensor 107, and a current sensor 108 are disposed in the first circuit A1 in addition to the motor 105.

The motor 105 receives power from the first power source 101 and is driven to generate a hydraulic braking pressure while the vehicle travels. For example, the motor 105 may be a 3-phase motor.

The motor 105 may operate a pump (not shown) which generates a hydraulic braking pressure. In other words, the pump operates according to driving of the motor 105 to generate the hydraulic braking pressure.

The switch 103 is disposed between the first power source 101 and the motor 105 and controls on/off of the power supplied from the first power source 101 to the motor 105. The switch 103 may transmit information on one or more of a voltage and a current supplied from the first power source 101 to the controller 110.

The inverter 104 is disposed between the first power source 101 and the motor 105 and converts power supplied from the first power source 101 to the motor 105. More specifically, the inverter 104 may be disposed between the switch 103 and the motor 105.

The inverter 104 may convert DC power supplied from the first power source 101 to alternating current (AC) power. As described above, the motor 105 may be the 3-phase motor, and the inverter 104 may convert the DC power of the first voltage supplied from the first power source 101 to the AC power which may drive the 3-phase motor.

The inverter 104 may include a plurality of field effect transistors (FETs) which operate according to control of the controller 110. As the FETs of the inverter 104 operate, the power of the first voltage supplied by the first power source 101 may be supplied for a U-phase, a V-phase, and a W-phase of the motor.

The inverter 104 may be operated by an inverter control signal transmitted by the controller 110. In this case, the inverter control signal may be a pulse width modulation (PWM) type signal.

The motor driver 106 converts the inverter control signal transmitted by the controller 110 to a signal for operating the inverter 104. The motor driver 106 may convert a voltage of the inverter control signal transmitted by the controller 110 to a voltage by which the inverter 104 may be operated and provide the converted voltage to the inverter 104.

For example, when the inverter control signal is a PWM signal having a voltage level corresponding to an operating voltage of the controller 110, the motor driver 106 may change a voltage level of the inverter control signal to a voltage level at which the inverter 104 may be operated.

The motor position sensor 107 senses a position of the motor 105. Motor position information sensed by the motor position sensor 107 may be used for controlling the motor 105. The motor position sensor 107 may transmit the motor position information to the controller 110.

The current sensor 108 senses a current of the motor 105. Motor current information sensed by the current sensor 108 may be used for controlling the motor 105. The current sensor 108 may transmit the motor current information to the controller 110.

In one embodiment of the present disclosure, a regulator 109, a valve 111, an electronic parking brake driver 112, a pedal displacement sensor 113, a pressure sensor 114, and a wheel speed sensor 115 may be disposed in the second circuit A2 in addition to the controller 110.

The controller 110 receives power from the second power source 102 and controls the motor 105. The controller 110 may include one or more micro controller units (MCUs).

The controller 110 may control the motor 105 by controlling the inverter 104 which converts power supplied from the first power source 101 to the motor 105. In other words, the controller 110 may transmit an inverter control signal for controlling the inverter 104.

The inverter control signal may be a PWM type signal. In this case, a voltage level of the inverter control signal may have an operating voltage of the controller 110.

The controller 110 may transmit the inverter control signal to the motor driver 106. The voltage level of the inverter control signal may have the operating voltage of the controller 110 and may be different from a voltage by which the inverter 104 may be operated. As described above, a voltage of the inverter control signal transmitted by the controller 110 may be converted to a voltage by which the inverter 104 is operated by the motor driver 106 and provided to the inverter 104.

The controller 110 may receive monitoring information on one or more of a voltage and a current supplied from the first power source 101 from the switch 103. The controller 110 may determine whether the first power source 101 supplies power normally on the basis of the monitoring information received from the switch 103.

The controller 110 supplies power to the motor position sensor 107. In addition, the controller 110 receives motor position information from the motor position sensor 107. The motor position sensor 107 does not need power having a higher operating voltage than that of the motor 105 when operating. Accordingly, it is efficient for the controller 110 operating with a voltage level lower than that of the first voltage to supply power to the motor position sensor 107.

Meanwhile, the controller 110 may supply power to the valve 111, the electronic parking brake driver 112, the pedal displacement sensor 113, the pressure sensor 114, and the wheel speed sensor 115. In addition, the controller 110 may control the valve 111 and the electronic parking brake driver 112. In addition, the controller 110 may receive pedal displacement information from the pedal displacement sensor 113, braking pressure information form the pressure sensor 114, and wheel speed information from the wheel speed sensor 115.

The regulator 109 is disposed between the second power source 102 and the controller 110 and adjusts a voltage of power supplied from the second power source 102 to the controller 110. In one embodiment of the present disclosure, the regulator 109 may be provided as an application specific integrated circuit (ASIC).

An operating voltage of the controller 110 may be a lower voltage than the second voltage supplied by the second power source 102. For example, the second voltage may be 12 V, and the operating voltage of the controller 110 may be 3.3 V. In this case, the regulator 109 may change the voltage of 12 V supplied from the second power source 102 to 3.3 V.

The valve 111 adjusts transmission of a hydraulic braking pressure generated according to driving of the motor 105. A plurality of valves 111 may be disposed in a hydraulic circuit in which the hydraulic braking pressure is transmitted. For example, the valve 111 may be a solenoid valve.

The valve 111 may be controlled by the controller 110. In other words, the controller 110 may receive power from the second power source 102 and control the valve 111.

The electronic parking brake driver 112 controls an electronic parking brake to provide a parking braking force for maintaining a parked state when the vehicle is parked. For example, the electronic parking brake may be a motor on caliper (MoC) type parking brake.

The electronic parking brake driver 112 may be controlled by the controller 110. That is, the controller 110 may supply power to the electronic parking brake driver and transmit a control signal for controlling the electronic parking brake.

The pedal displacement sensor 113 senses displacement of the brake pedal of the vehicle. The pedal displacement sensor 113 may sense one or more of an angle and a moving distance of the brake pedal. Pedal displacement information sensed by the pedal displacement sensor 113 may be used when the controller 110 controls the motor 105.

The pedal displacement sensor 113 may be controlled by the controller 110. Specifically, the controller 110 may supply power to the pedal displacement sensor 113. In addition, the controller 110 may receive the pedal displacement information from the pedal displacement sensor 113.

The pressure sensor 114 senses a braking pressure supplied to a wheel of the vehicle. The pressure sensor 114 may sense the braking pressure supplied to the wheel of the vehicle such that a brake pad presses a disk. Braking pressure information sensed by the pressure sensor 114 may be used when the controller 110 controls the motor 105.

The pressure sensor 114 may be controlled by the controller 110. More specifically, the controller 110 may supply power to the pressure sensor 114. In addition, the controller 110 may receive the braking pressure information from the pressure sensor 114.

The wheel speed sensor 115 senses a wheel speed of the vehicle. The wheel speed sensor 115 may be disposed on each of a plurality of wheels of the vehicle. Wheel speed information sensed by the wheel speed sensor 115 may be used as one variable when the controller 110 controls the motor 105.

The wheel speed sensor 115 may be controlled by the controller 110. More specifically, the controller 110 may supply power to the wheel speed sensor 115. In addition, the controller 110 may receive the wheel speed information from the wheel speed sensor 115.

The brake system 100 according to one embodiment of the present disclosure has been described above in detail. Hereinafter, a brake system 200 according to another embodiment of the present disclosure will be described.

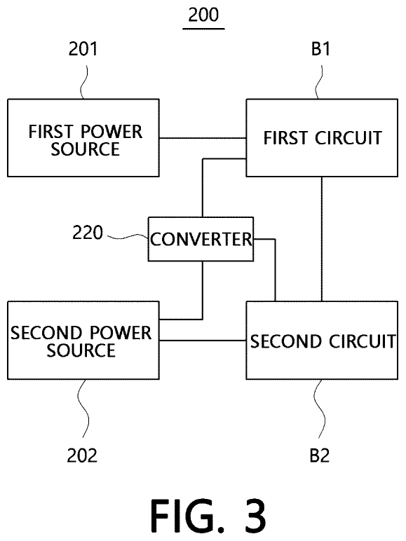

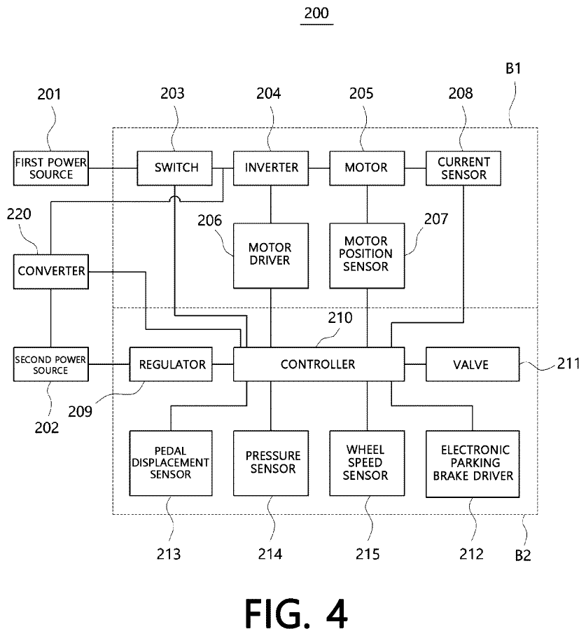

FIG. 3 is a schematic view illustrating a configuration of a brake system according to another embodiment of the present disclosure. In addition, FIG. 4 is a detailed view illustrating the configuration of the brake system according to another embodiment of the present disclosure.

Referring to FIGS. 3 and 4, the brake system 200 according to another embodiment of the present disclosure includes a first power source 201 and a second power source 202. The first power source 201 and the second power source 202 provides a dualized power structure.

The first power source 201 supplies power of a first voltage. The first power source 201 may be a battery which supplies DC power having the first voltage. In this case, the first voltage may be 48 V.

The second power source 202 supplies power of a second voltage that is lower than the first voltage. The second power source 202 may be a battery which supplies DC power having the second voltage. In this case, the second voltage may be 12 V.

The power of the first voltage supplied by the first power source 201 is used for driving a motor 205. Meanwhile, the power of the second voltage supplied by the second power source 202 is used for operating a controller 210 which controls the motor 205.

The brake system 200 according to another embodiment of the present disclosure may include a first circuit B1 including the motor 205 driven by the first power source 201 and components for driving or monitoring the motor 205 and a second circuit B2 including the controller 210 operated by the second power source 202.

In another embodiment of the present disclosure, a switch 203, an inverter 204, a motor driver 206, a motor position sensor 207, and a current sensor 208 are disposed in the first circuit B1 in addition to the motor 205.

In another embodiment of the present disclosure, a regulator 209, a valve 211, an electronic parking brake driver 212, a pedal displacement sensor 213, a pressure sensor 214, and a wheel speed sensor 215 may be disposed in the second circuit B2 in addition to the controller 210.

The components disposed in the first circuit B1 and the second circuit B2 are the same as those in the brake system 100 according to one embodiment of the present disclosure. In other words, the motor 205, the switch 203, the inverter 204, the motor driver 206, the motor position sensor 207, the current sensor 208, the regulator 209, the valve 211, the electronic parking brake driver 212, the pedal displacement sensor 213, the pressure sensor 214, and the wheel speed sensor 215 are the same as the same components of one embodiment of the present disclosure. Accordingly, in the description of the brake system 200 according to another embodiment of the present disclosure, content overlapping the content described in the one embodiment of the present disclosure will be omitted.

The brake system 200 according to another embodiment of the present disclosure may further include a converter 220 when compared to the brake system 100 according to one embodiment of the present disclosure. Hereinafter, content related to the converter 220 will be described in detail.

The converter 220 is disposed between the second power source 202 and the motor 205, and boosts a voltage supplied by the second power source 202 to the first voltage. When the first power source 201 does not supply power, the converter 220 may allow the second power source 202 to serve as the first power source 201.

The converter 220 may be controlled by the controller 210. More specifically, when the first power source 201 does not supply power to the motor 205, the controller 210 boosts power supplied from the second power source 202 to the first voltage using the converter 220 and supplies the first voltage to the motor 205.

In this regard, the switch 203 may transmit monitoring information on one or more of a voltage and a current supplied from the first power source 201 to the controller 210. The controller 210 may receive the monitoring information of the voltage and the current, which are supplied from the first power source 201, from the switch 203 and determine whether the first power source 201 does not supply power to the motor 205 using the received monitoring information.

When it is determined that the first power source 201 does not supply power to the motor 205, the controller 210 boosts power supplied from the second power source 202 to the first voltage using the converter 220 and supplies the first voltage to the motor 205. Accordingly, even when the first power source 201 fails, the motor 205 may operate.

According to another embodiment of the present disclosure, even when the first power source 201 does not supply power while the vehicle travels, a hydraulic braking pressure can be continuously generated by the motor 205. Accordingly, a risk due to loss of a braking force can be avoided.

A brake system according to the present disclosure provides a dualized power structure in which a first power source for supplying a first voltage which is a relatively high voltage supplies power to a motor and a second power source for supplying a second voltage that is lower than the first voltage supplies power to a controller having a low driving voltage.

This structure improves driving efficiency of the motor and also allows a circuit for controlling the motor designed to correspond to the conventional existing power source for supplying a relatively low voltage to be used without change. Accordingly, in the present disclosure, efficiency in driving the motor can be improved when the motor is driven, and the economy of a circuit design can also be achieved.

According to the structure, in a brake system according to one aspect of the present disclosure, as a first power source is adopted as a power source for driving a motor, and a second power source for providing a lower voltage than that of the first power source is adopted as a power source of a controller for controlling the motor, both the efficiency of power usage and economy of the circuit configuration can be achieved.

In the brake system according to one aspect of the present disclosure, a dualized power source including a first power source for supplying a relatively high voltage and a second power source for supplying a relatively low voltage is used, redundancy is provided using the second power source and a converter when the first power source does not supply power, and thus safety of a vehicle is improved.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A brake system of a vehicle, comprising:
a first power source configured to supply first power of a first voltage;
a motor configured to receive the first power from the first power source and be driven to generate a hydraulic braking pressure;
a second power source configured to supply second power of a second voltage lower than the first voltage of the first power source; and
a controller configured to receive, from the second power source, the second power of the second voltage, lower than the first voltage supplied to the motor, and control the motor.

2. The brake system of claim 1, further comprising an inverter connected between the first power source and the motor and configured to convert the first power supplied from the first power source to the motor,
wherein the controller is configured to transmit an inverter control signal for controlling the inverter to the inverter.

3. The brake system of claim 2, further comprising a motor driver connected between the controller and the inverter and configured to convert the inverter control signal transmitted from the controller to a signal for operating the inverter.

4. The brake system of claim 1, further comprising one or more valves configured to adjust the hydraulic braking pressure,
wherein the controller is configured to receive the second power from the second power source and control the one or more valves.

5. The brake system of claim 1, further comprising one or more switches connected between the first power source and the motor and configured to selectively connect or disconnect the first power source to or from the motor.

6. The brake system of claim 5, wherein the controller is configured to receive, from the one or more switches, information related to one or more of a voltage or a current which are supplied from the first power source.

7. The brake system of claim 1, further comprising a regulator connected between the second power source and the controller and configured to adjust the second voltage supplied from the second power source and provide the adjusted second voltage to the controller.

8. The brake system of claim 1, further comprising a motor position sensor configured to sense a position of the motor,
wherein the controller is configured to supply third power to the motor position sensor and receive a signal associated with the sensed position of the motor from the motor position sensor.

9. The brake system of claim 1, further comprising a pedal displacement sensor configured to sense displacement of a brake pedal of the vehicle,
wherein the controller is configured to supply fourth power to the pedal displacement sensor and receive a signal associated with the sensed displacement of the brake pedal of the vehicle from the pedal displacement sensor.

10. The brake system of claim 1, further comprising a pressure sensor configured to sense a braking pressure supplied to a wheel of the vehicle,
wherein the controller is configured to supply fifth power to the pressure sensor and receive a signal associated with the sensed braking pressure from the pressure sensor.

11. The brake system of claim 1, further comprising a wheel speed sensor configured to sense a speed of a wheel of the vehicle,
Wherein the controller is configured to supply sixth power to the wheel speed sensor and receive a signal associated with the sensed speed of the wheel of the vehicle from the wheel speed sensor.

12. The brake system of claim 1, further comprising an electronic parking brake driver configured to control an electronic parking brake to provide a parking braking force,
wherein the controller is configured to supply seventh power to the electronic parking brake driver and transmit a control signal for controlling the electronic parking brake.

13. A brake system of a vehicle, comprising:
a first power source configured to supply first power of a first voltage;
a motor configured to receive the first power from the first power source for generating a hydraulic braking pressure;
a second power source configured to supply second power of a second voltage lower than the first voltage;
a controller configured to receive the second power from the second power source and control the motor; and
a converter connected between the second power source and the motor and configured to increase the second voltage, supplied by the second power source, to the first voltage,
wherein the controller is configured to, in response to not supplying the first power to the motor from the first power source, control the converter to increase the second voltage, supplied from the second power source, to the first voltage so that the first voltage is supplied to the motor by the converter.

14. The brake system of claim 13, further comprising an inverter connected between the first power source and the motor and convert the first power supplied from the first power source to the motor,
wherein the controller is configured to transmit an inverter control signal for controlling the inverter.

15. The brake system of claim 14, further comprising a motor driver connected between the controller and the inverter and convert the inverter control signal transmitted by the controller to a signal for operating the inverter.

16. The brake system of claim 13, further comprising one or more valves configured to adjust the hydraulic braking pressure,
wherein the controller is configured to receive the second power from the second power source and control the one or more valves.

17. The brake system of claim 13, further comprising one or more switches connected between the first power source and the motor and configured to selectively connect or disconnect the first power source to or from the motor.

18. The brake system of claim 17, wherein the controller is configured to receive, from the one or more switches, information related to one or more of a voltage or a current which are supplied from the first power source.

19. The brake system of claim 13, further comprising a regulator connected between the second power source and the controller and configured to adjust the second voltage supplied from the second power source and provide the adjusted second voltage to the controller.

20. The brake system of claim 13, further comprising a motor position sensor configured to sense a position of the motor,
wherein the controller is configured to supply power to the motor position sensor and receive a signal associated with the sensed position of the motor from the motor position sensor.
